(19) United States
(12) Patent Application Publication
(10) Pub. No.: US 2024/0264855 A1
(43) Pub. Date: Aug. 8, 2024

(54) VIRTUAL DESKTOP DURING DEVICE SETUP

(71) Applicant: Microsoft Technology Licensing, LLC, Redmond, WA (US)

(72) Inventors: Camilla Angela SMITH, Seattle, WA (US); Jonathan Madison ANDES, Seattle, WA (US); Juan Carlos LUCIANI, Highland, UT (US); Deepika WADHWA, Bothell, WA (US); Heena Sharad MACWAN, Kirkland, WA (US); Juanita Jestina BAPTISTE, Sacramento, CA (US); Peter John RICHARDS, Snoqualmie, WA (US); Hung M. DANG, Seattle, WA (US)

(21) Appl. No.: 18/165,651

(22) Filed: Feb. 7, 2023

(51) Int. Cl. G06F 9/455; G06F 9/451

(52) U.S. Cl. CPC G06F 9/45558; G06F 9/452; G06F 2009/45562; G06F 2009/45591

(57) ABSTRACT

A virtual desktop enables productivity during device setup. An enrollment request on behalf of a user is received from a computing device associated. The enrollment request includes the user's identity and corresponds to a setup phase of an operating system of the computing device. A deployment configuration assigned to the user is identified based on the user's identity. The deployment configuration includes device configuration information specifying instructions for configuring the computing device and link information specifying a virtual machine provisioned according to the device configuration information. Connection instructions to establish a connection between the computing device and the virtual machine are transmitted to the computing device. The computing device is monitored to determine a completion of the setup phase. Responsive to the completion, a prompt is provided to the virtual machine indicative of the completion of the setup phase.

### BACKGROUND

In enterprise network systems, a company sets policies regarding how computing devices distributed to users are configured, including, for example, device settings for a computing device and applications to be installed on the computing device. During the setup phase of a new (unconfigured) computing device (also referred to as an “out of box experience”) the operating system is installed, the device is configured, and/or applications are installed in accordance with these policies. A company may require any number (e.g., ones, tens, hundreds, etc.) of applications to be installed on an employee's computing device during a setup phase. The setup phase may utilize network resources (e.g., of an enterprise intranet and/or of a cloud network platform associated with the enterprise network) to access resources to perform the setup phase. Alternatively, a corporate image of an operating system that specifies which applications to install on a computing device is used to setup a new computing device.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments described herein enable virtual desktop-based productivity during device setup. In an aspect of the present disclosure, an enrollment request on behalf of a first user is received from a first computing device associated with the first user. The enrollment request comprises the identity of the first user and corresponds to a setup phase of an operating system of the first computing device. A deployment configuration assigned to the first user is identified based on the identity of the first user. The deployment configuration comprises device configuration information and link information. The device configuration information specifies instructions for configuring the first computing device. The link information specifies a virtual machine provisioned according to the device configuration information. Connection instructions are transmitted to the first computing device, the connection instructions comprising instructions to establish a connection between the first computing device and the virtual machine. The first computing device is monitored to determine a completion of the setup phase. Responsive to the completion of the setup phase, a prompt is provided to the virtual machine, the prompt indicative of the completion of the setup phase.

In a further aspect of the present disclosure, instructions for configuring the first computing device comprise instructions to install an application on the first computing device. The established connection enables the user to interact at the first computing device with an instance of the application at the virtual machine prior to installation of the application on the first computing device.

In a further aspect of the present disclosure, the deployment configuration assigned to the first user is received from a second computing device associated with a second user. The deployment configuration assigned to the first user is stored in association with the identity of the first user.

In a further aspect of the present disclosure, a plurality of deployment configurations are provided to a virtual machine provisioner. The plurality of deployment configurations include the deployment configuration assigned to the first user. The link information is received from the virtual machine provisioner and stored in association with the device configuration information.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of a system for enabling virtual desktop during device setup in accordance with an example embodiment.

FIG. 2 shows a block diagram of a system for generating, storing, and updating deployment configurations in accordance with an example embodiment.

FIG. 3 shows a flowchart of a process for storing a deployment configuration in accordance with an embodiment.

FIG. 4 shows a block diagram of a system for enabling virtual desktop during device setup in accordance with an example embodiment.

FIG. 5 shows a flowchart of a process for enabling virtual desktop during device setup in accordance with an example embodiment.

FIG. 6 shows a flowchart of a process for transmitting connection instructions in accordance with an example embodiment.

FIG. 7 shows a flowchart of a process for performing a remedial action in accordance with an example embodiment.

FIG. 8A shows a flowchart of a process for enabling application access during computing device setup in accordance with an example embodiment.

FIG. 8B shows a flowchart of a process for monitoring the setup phase of a computing device, in accordance with an example embodiment.

FIG. 8C shows a flowchart of a process for performing a remedial action in accordance with an example embodiment.

FIG. 9A shows an example remote desktop user interface for enabling a user to interact with applications at a virtual machine in accordance with an example embodiment.

FIG. 9B shows an example remote desktop user interface for presenting a prompt indicative of the completion of a setup phase in accordance with an example embodiment.

FIG. 9C shows an example remote desktop user interface for presenting a prompt for user input in accordance with an example embodiment.

FIG. 9D shows an example remote desktop user interface for presenting a prompt to end an established connection with a virtual machine in accordance with an example embodiment.

FIG. 10 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

As set forth in the Background section, in enterprise network systems, a company sets policies regarding how computing devices distributed to users are configured, including, for example, device settings for the computing devices and applications to be installed on the computing devices. During the setup phase of a new (unconfigured) computing device (also referred to as an “out of box experience”) the operating system is installed, the device is configured, and/or applications are installed in accordance with these policies. A company (e.g., an admin user on behalf of the company) may require any number (e.g., ones, tens, hundreds, etc.) of applications to be installed on an employee's computing device during a setup phase. The setup phase may utilize network resources (e.g., of an enterprise intranet and/or of a cloud network platform associated with the enterprise network) to access resources to perform the setup phase. Alternatively, a corporate image of an operating system that specifies which applications to install on the computing device is used to setup a new computing device.

However, these processes for setting up a computing device are presented with several challenges. For instance, users (e.g., employees) of an enterprise network typically setup their computing devices in an asynchronous manner, which typically prevents centralized orchestration of setting up multiple devices, increases the chance for errors to occur, slows access to resources, and/or results in failed setup of a computing device altogether. With respect to using a corporate image, the imaging process typically takes a long time, and usually renders the computing device unusable during the process. Furthermore, imaging processes that utilize a physical imaging device (e.g., a universal serial bus (USB) key) are limited in how many devices can be setup at a time by the number of physical imaging devices available. Further still, corporate images stored on physical imaging devices require manual updates when an operating system or application is updated, otherwise the end user will have to update the operating system and/or application after the imaging process. Moreover, user requirements and/or productivity requirements often require computing device setup to be conducted and completed quickly. Background activities such as error monitoring and network throttling may be reduced to prioritize speed of setup, potentially increasing the chance for errors, impact on network bandwidth, and/or failure of installation.

Embodiments described herein provide virtual desktops during the setup phase in a manner intended to address the above challenges. For example, embodiments described herein receive deployment configurations from an admin user (e.g., administrators, managers, enterprise administrators, service team users, (e.g., operating system) developers, etc.) that comprise device configuration information. Device configuration information specifies instructions for configuring computing devices for users. Examples of device configuration information include, but are not limited to, a type of operating system, device settings, services into which to enroll and/or sign-in a user, applications to install on the computing device, and/or any other information related to how to configure a computing device and/or an operating system installed thereon during the setup phase of the device. For example, in accordance with an enterprise network system embodiment, device configuration information specifies instructions for configuring a computing device of a user in accordance with one or more policies of the enterprise network system. In embodiments, deployment configurations are assigned to users. For instance, deployment configurations in accordance with an embodiment are stored in association with respective identities of corresponding assigned users. In some embodiments, deployment configurations are assigned to users based on policies. For instance, deployment configurations may be assigned to users based on one or more policies that specify deployment configurations based on security clearance of a user, a job title of the user, administrative rights of a user, a department a user is associated with, and/or any other attributes of a user that may be used to determine whether or not to assign particular deployment configurations to the user.

Embodiments described herein leverage virtual machines to enable use of a virtual desktop during the setup phase of a computing device. These virtual machines are provisioned in accordance with the device configuration information and link information of the provisioned virtual machines is stored in association with the device configuration information (e.g., as the (e.g., updated) deployment configurations). Link information specifies one or more of the provisioned virtual machines. For instance, link information may specify a particular provisioned virtual machine, a pool of provisioned virtual machines, a server or servers that hosts one or more provisioned virtual machines, a universal resource locator (URL) of a provisioned virtual machine or pool of provisioned virtual machines, and/or any other information suitable for identifying and/or accessing one or more provisioned virtual machines.

Techniques described herein provide a virtual desktop for use during a setup phase of a computing device. For instance, an enrollment request on behalf of a user (e.g., an end user (e.g., employee users, enterprise users, customer users, individual users, family users, etc.)) is received from a computing device associated with the user. The enrollment request comprises the identity of the user and corresponds to a setup phase of an operating system of the computing device. A deployment configuration assigned to the user (e.g., by an admin user or on behalf of an admin user) is identified based on the identity of the user. The deployment configuration comprises device configuration information that specifies instructions for configuring the computing device and link information that specifies a virtual machine provisioned according to the device configuration information. Connection instructions are transmitted to the computing device. The connection instructions comprise instructions to establish a connection between the computing device and the virtual machine. The computing device is monitored to determine a completion of the setup phase. Responsive to the completion of the setup phase, a prompt is provided to the virtual machine indicative of the completion of the setup phase.

As such, methods, systems, and computer program products are provided for enabling use of a virtual desktop during the setup phase of an operating system of a computing device. Embodiments described herein may provide an out of box experience that is reliable while enabling an end user to utilize applications to be installed on the computing device prior to the installation (and throughout the installation process). Furthermore, because the end user is able to utilize applications prior to their installation, the speed in which the operating system and computing device are setup may be reduced to allow for additional error monitoring, mitigation, and/or resolution techniques. Moreover, the setup process may be slowed to reduce network traffic, conserve resource usage, and/or improve load balancing.

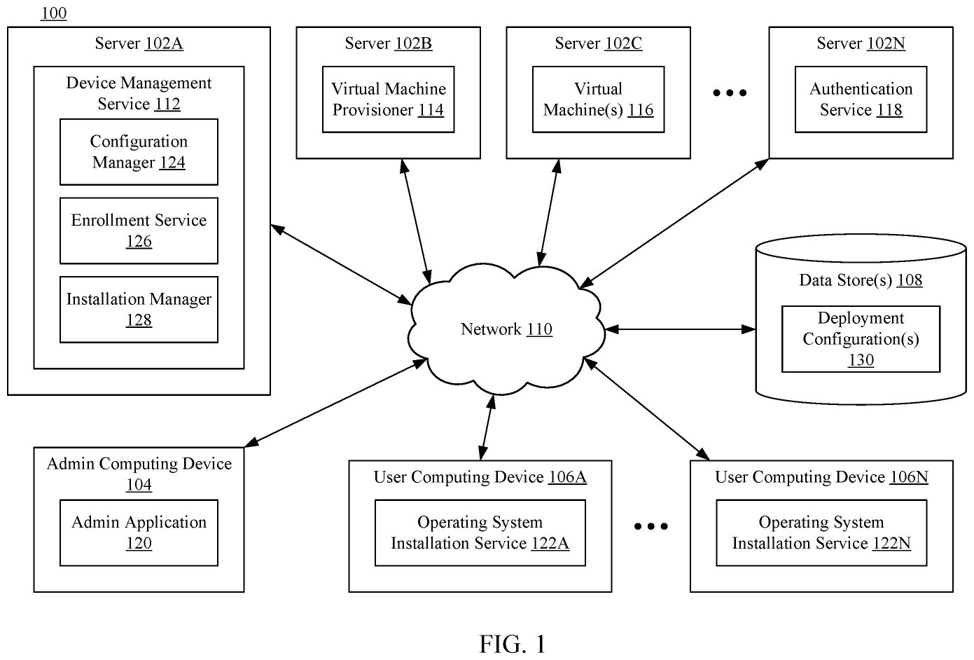

Embodiments may be configured in various ways in various embodiments. For instance, FIG. 1 shows a block diagram of a system 100 for enabling virtual desktop during device setup in accordance with an example embodiment. As shown in FIG. 1, system 100 includes servers 102A-102N, admin computing device 104, user computing devices 106A-106N, and one or more data stores 108 (“data store 108” hereinafter). Server 102A includes a device management service 112, server 102B includes a virtual machine provisioner 114, server 102C includes one or more virtual machines 116 (“virtual machines 116” hereinafter), and server 102N includes authentication service 118. Device management service 112 includes a configuration manager 124, an enrollment service 126, and an installation manager 128. In embodiments, servers 102A-102N, admin computing device 104, user computing devices 106A-106N, and data store 108 are communicatively coupled via one or more networks 110 (“network 110” hereinafter), comprising one or more of local area networks (LANs), wide area networks (WANs), enterprise networks, the Internet, etc., and including one or more of wired and/or wireless portions. System 100 and its components and/or subcomponents may be implemented in an enterprise network system or a cloud service platform, and are described in further detail as follows.

Data store 108 maintains data accessible to one or more components of system 100. Examples of data store 106 include, but are not limited to, a database, a file repository, and/or any other type of storage suitable for storing data described herein. Examples of data maintained by data store 108 include, but are not limited to, deployment configurations, database objects (e.g., tables (e.g., a table mapping deployment configurations to user identities), directories (e.g., that include user identifying information), etc.), structured data, unstructured data, semi-structured data, data files, etc. As shown in FIG. 1, data store 106 stores deployment configurations 130, as discussed further below.

Admin computing device 104 include any computing devices of admin users and user computing devices 106A-106N include any computing devices of end users (e.g., employee users, that may access network-accessible resources such as servers 102A-102N over network 110. System 100 may include fewer or more admin computing devices and/or user computing devices than depicted in FIG. 1. Admin computing device 104 and user computing devices 106A-106N (“computing devices 104-106”, collectively) may each be any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. Each of computing devices 104-106 store data and execute computer programs, applications, and/or services.

For example, admin computing device 104 as shown in FIG. 1 includes an admin application 120 that enables an admin user to perform administrative operations with respect to user identities (e.g., users associated with user computing devices 106A-106N). Example administrative operations include, but are not limited to, generating deployment configurations, assigning deployment configurations to user identities, managing deployment configurations, managing user accounts, managing virtual machines, and/or any other operations that may be performed with respect to system 100 and/or user accounts associated with system 100. For instance, an admin user in accordance with an embodiment interacts with admin computing device 104 to use admin application 120 to generate deployment configurations and assign the deployment configurations to users of user computing devices 106A-106N.

As also shown in FIG. 1, user computing devices 106A-106N include respective operating system installation services 122A-122N that enable installation of an operating system, configuration of the operating system, installation of applications, and/or configuration of installed applications on a respective device of user computing devices 106A-106N.

Servers 102A-102N and any additional resources define a network accessible server infrastructure. In example embodiments, servers 102A-102N from a network-accessible server set, such as an enterprise server network or a cloud computing server network. For example, servers 102A-102N in accordance with an embodiment comprise a group or collection of servers (e.g., computing devices) that are each accessible by a network such as an enterprise network (e.g., in an “enterprise” embodiment) or the Internet (e.g., in a “cloud-based” embodiment) to store, manage, and process data. System 100 may include any number of servers, fewer or greater than the number of servers 102A-102N shown in FIG. 1. Each of servers 102A-102N are configured to execute one or more services (including microservices), applications, and/or supporting services. A “supporting service” is a cloud computing service/application that manages a set of servers (e.g., a cluster of servers) to operate as network-accessible (e.g., cloud-based) computing resources for users. Examples of supporting services include Microsoft® Azure®, Amazon Web Services™ Google Cloud Platform™, IBM® Smart Cloud, etc. A supporting service may be configured to build, deploy, and manage applications and services on the corresponding set of servers. Each instance of the supporting service may implement and/or manage a set of focused and distinct features or functions on the corresponding server set, including virtual machines (e.g., virtual machines 116), operating systems, application services, storage services, database services, messaging services, etc. Supporting services may be coded in any programming language. Each of servers 102A-102N may be configured to execute any number of services and/or other resources. For example, device management service 112, virtual machine provisioner 114, virtual machines 116, and authentication service 118 in accordance with an embodiment are implemented as services executed by respective servers 102A, 102B, 102C, and 102N. Furthermore, in accordance with another embodiment, device management service 112 is implemented by multiple servers other than (or including) server 102A. In accordance with another embodiment, device management service 112 (or one or more components of device management service 112), virtual machine provisioner 114, virtual machines 116, and/or authentication service 118 are implemented by the same server.

Virtual machine provisioner 114 is a service that provisions virtual machines (e.g., of virtual machines 116). For instance, virtual machine provisioner 114 in accordance with an embodiment provisions virtual machines 116 in accordance with deployment configurations 130, as described elsewhere herein.

Authentication service 118 is a service that is authenticates user identities. For instance, authentication service 118 in accordance with an embodiment authenticates a user associated with user computing device 106A during a setup phase of the operating system of user computing device 106A. In accordance with an embodiment, authentication service 118 creates, maintains, and/or manages identity information associated with users while providing authentication services. In accordance with an embodiment, authentication service 118 determines an access policy associated with a user (e.g., a client-side access policy, an operating system-based policy, a download access policy, an IP-based access policy, a geolocation-based access policy, a proxy access policy, a group access policy, and/or any other policy used to determine whether or not a user should be granted access to a resource of system 100, an account associated with a user, and/or the like).

Device management service 112 is a service that manages the configuration of user computing devices 106A-106N and the installation of operating systems and/or applications on user computing devices 106A-106N. As shown in FIG. 1, device management service 112 includes configuration manager 124, enrollment service 126, and installation manager 128. Configuration manager 124 manages deployment configurations (e.g., of deployment configurations 130) for (e.g., new) user computing devices. For instance, configuration manager 124 receives deployment configurations generated by and assigned to users by an admin user of admin application 120. The deployment configurations include device configuration information for computing devices assigned to users. Configuration manager 124 stores the deployment configurations as deployment configurations 130 in data store 108.

Configuration manager 124 also enables other services of system 100 to access information regarding deployment configurations 130. For instance, configuration manager 124 enables virtual machine provisioner 114 to access deployment configurations 130 to provision virtual machines of virtual machines 116 according to device configuration information of deployment configurations 130. Furthermore, configuration manager 124 enables enrollment service 126 to access deployment configurations 130 to perform operations associated with a setup phase of an operating system of a computing device (e.g., user computing devices 106A-106N).

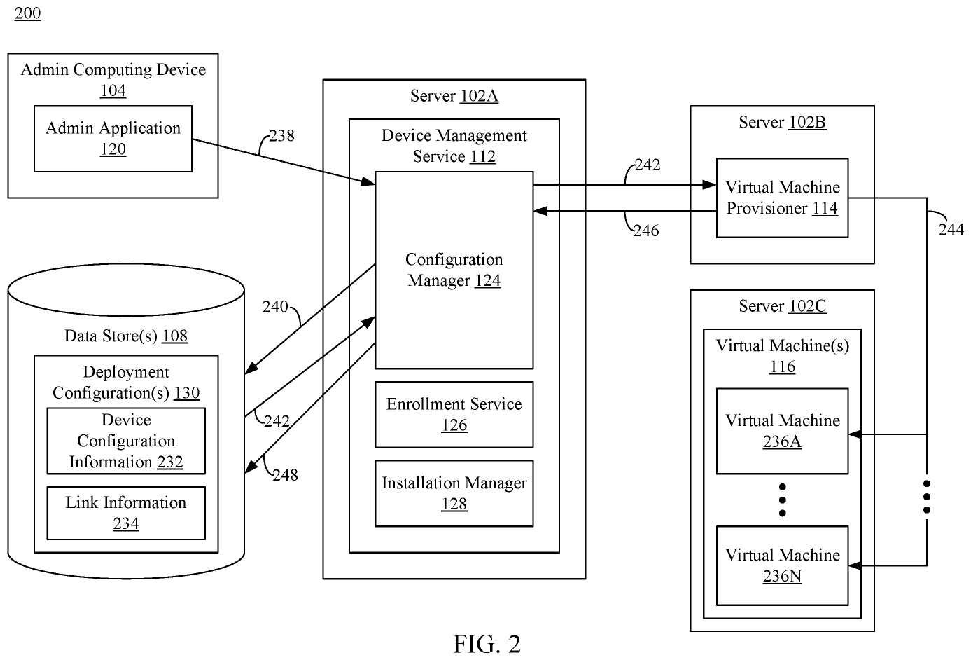

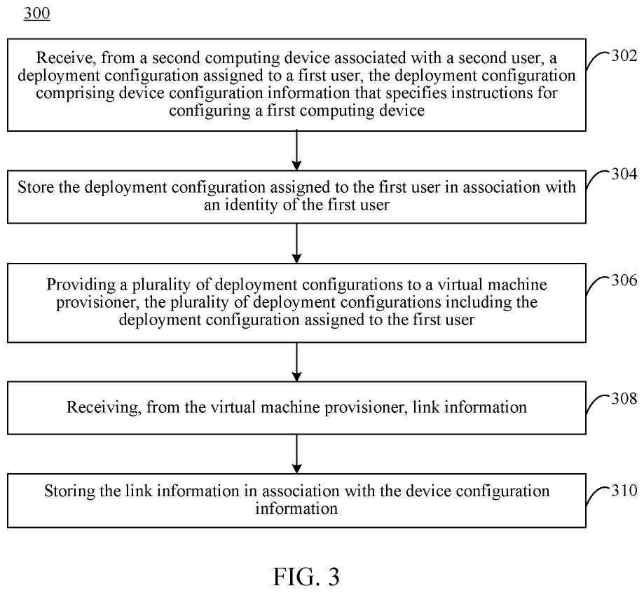

Additional details regarding the management of deployment configurations are discussed with respect to FIGS. 2 and 3, as well as elsewhere herein.

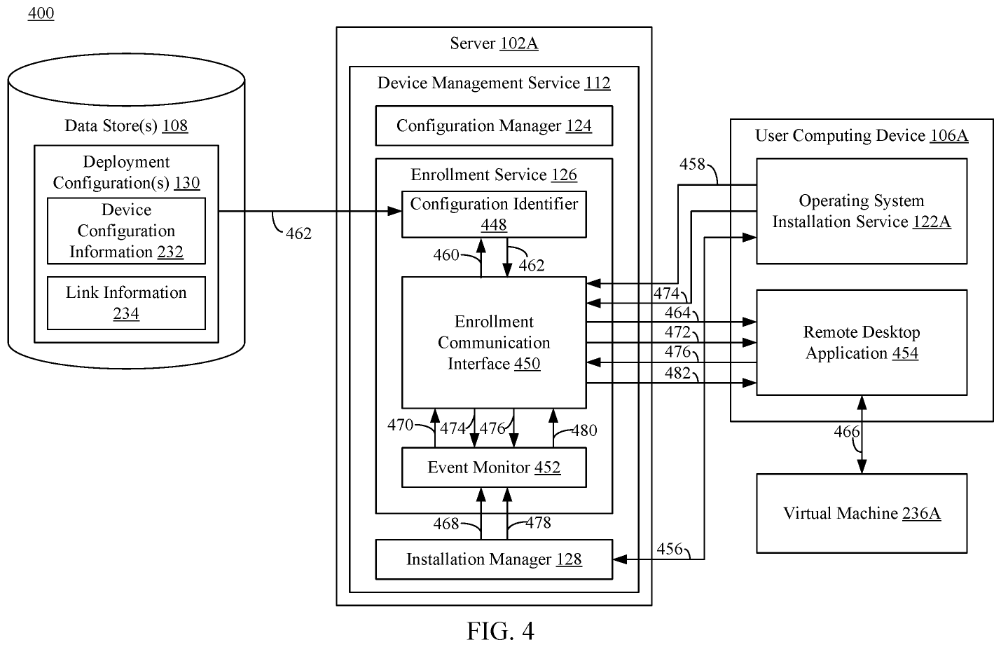

Enrollment service 126 is a service that manages user access to applications and devices. In particular, (e.g., during the setup phase of a computing device) enrollment service 126 receives requests to enroll computing devices by users, determines a deployment configuration for a respective computing device based on an identity of a requesting user, and transmits instructions to establish a connection with a provisioned virtual machine. For example, suppose a user associated with user computing device 106A initiates a setup phase for user computing device 106A by interacting with operating system installation service 122A. As part of the setup phase, user computing device 106A transmits an enrollment request to enrollment service 126. Enrollment service 126 determines a deployment configuration (e.g., of deployment configurations 130) assigned to the user associated with user computing device 106A, the deployment configuration comprising link information specifying virtual machines of virtual machines 116 that are provisioned according to device configuration information of the determined deployment configuration. In this context, enrollment service 126 transmits instructions to user computing device 106A to establish a connection with a provisioned virtual machine, thereby enabling the user to interact with user computing device 106A to use applications of the provisioned virtual machine. Additional details regarding receiving enrollment requests, determining deployment configurations, and transmitting instructions are discussed with respect to FIGS. 4-6, as well as elsewhere herein.

Enrollment service 126 also monitors computing devices (e.g., during the setup phase). Enrollment service 126 may monitor a computing device to determine completion of a setup phase, detect an error event, determine the progress of the setup phase, determine resource usage of the setup phase, and/or otherwise monitor a computing device during the setup phase. In accordance with one or more embodiments, enrollment service 126 provides a prompt indicative of an event or other information based on the monitoring. For instance, continuing the example above, enrollment service 126 monitors user computing device 106A to determine a completion of the setup phase. In response to the completion of the setup phase, enrollment service 126 provides user computing device 106A a prompt indicative of the completion of the setup phase. Additional details regarding monitoring computing devices are discussed with respect to FIGS. 4, 5, and 7, as well as elsewhere herein.

Installation manager 128 is a service that manages the installation of an operating system and/or applications on a computing device. For example, installation manager 128 manages the execution of operating system installation services 122A-122N on respective user computing devices 106A-106N. As shown in FIG. 1, installation manager 128 is a separate service from enrollment service 126. In accordance with an alternative embodiment, enrollment service 126 and installation manager 128 are integrated into a single service (e.g., an enrollment and installation management service).

As discussed above, techniques described herein may generate, store, and update deployment configurations in various ways, in embodiments. For example, FIG. 2 shows a block diagram of a system 200 for generating, storing, and updating deployment configurations in accordance with an example embodiment. As shown in FIG. 2, system 200 includes server 102A executing device management service 112 (that includes configuration manager 124, enrollment service 126, and installation manager 128), server 102B executing virtual machine provisioner 114, server 102C hosting virtual machines 116, admin computing device 104 executing admin application 120, and data store 108 storing deployment configurations 130, as described above with reference to FIG. 1. As also shown in FIG. 2, virtual machines 116 include virtual machines 236A-236N and deployment configurations 130 include device configuration information 232 and link information 234. For illustrative purposes, system 200 is described below with respect to FIG. 3. FIG. 3 shows a flowchart 300 of a process for storing deployment configuration in accordance with an embodiment. System 200 of FIG. 2 may operate according to flowchart 300 in embodiments. Not all steps of flowchart 300 need be performed in all embodiments. Further structural and operational embodiments will be apparent to persons skilled in the relevant art(s) based on the following descriptions of FIGS. 2 and 3.

Flowchart 300 begins with step 302. In step 302, a deployment configuration assigned to a first user is received from a second computing device associated with a second user. The deployment configuration comprises device configuration information that specifies instructions for configuring a first computing device. For example, configuration manager 124 of FIG. 2 receives a configuration request 238 from admin application 120 executing on admin computing device 104. Configuration request 238 comprises one or more deployment configurations, each deployment configuration includes device configuration information that specifies instructions for configuring a respective computing device. In accordance with an embodiment, deployment configurations are assigned to one or more users. For instance, in an enterprise embodiment, each deployment configuration included in configuration request 238 is assigned to at least one employee user of a company. Deployment configurations may be assigned to individual users, assigned to groups of users, or assigned to users based on attributes of the user (e.g., job title, security clearance, department, and/or the like). Deployment configurations include device configuration information that specifies instructions for configuring computing devices associated with assigned users (e.g., user purchased computing devices, company issued computing devices, etc.).

In accordance with some embodiments, deployment configurations may be indirectly assigned to users. For instance, an admin user may assign deployment configurations to users with certain attributes. As a non-limiting example, suppose an admin user assigns a first deployment configuration to all users in Department A, a second deployment configuration to all users in Department B, and a third deployment configuration to all manager users. In this context, configuration request 238 comprises the three deployment configurations and specifies which “user groups” (attributes) the respective deployment configuration is assigned to. This way, the admin user is not required to assign deployment configurations to individual users and the admin computing device is not required to maintain a database of which users have which attributes or which users belong to a particular user group.

In accordance with an alternative embodiment, configuration request 238 comprises a “master image”. The master image specifies deployment configurations for more than one user. In this context, an admin user interacts with admin application 120 to generate the master image that specifies settings, policies, and/or applications for the image. Furthermore, configuration request 238 in this alternative embodiment may include a list of users (or user identities) associated with (e.g., assigned to) the master image. For example, in an enterprise embodiment, configuration request 238 comprises a master image and a list of user IDs corresponding to employees assigned to the master image.

Referring back to FIG. 3, in step 304, the deployment configuration assigned to the first user is stored in association with an identity of the first user. For example, configuration manager 124 stores deployment configurations included in configuration request 238 in data store 108. As shown in FIG. 2, configuration manager 124 transmits a storage signal 240 to data store 108 for storing the deployment configurations included in configuration request 238. Storage signal 240 comprises the deployment configurations. In accordance with an embodiment, storage signal 240 also includes identities of respective users. As shown in FIG. 2, the deployment configurations are stored in data store 108 as deployment configurations 130. In accordance with an embodiment, deployment configurations 130 are associated with (e.g., mapped to) identities of respective users. The identities of users may include, but are not limited to, individual user identities that correspond to respective users and/or user group identities that correspond to a group of users (e.g., employee users in the same department, employee users of the same company, users assigned to the same security group, and/or the like). As shown in FIG. 2, deployment configurations 130 include respective device configuration information 232.

In step 306, a plurality of deployment configurations are provided to a virtual machine provisioner. The plurality of deployment configurations include the deployment configuration assigned to the first user. For example, configuration manager 124 retrieves a plurality of deployment configurations 242 and transmits plurality of deployment configurations 242 to virtual machine provisioner 114. Plurality of deployment configurations 242 may include a portion of or the entirety of deployment configurations 130. For instance, plurality of deployment configurations 242 in accordance with an embodiment includes deployment configurations of deployment configurations 130 that have not been associated with a provisioned virtual machine. In accordance with another embodiment, plurality of deployment configurations 242 includes deployment configurations of deployment configurations 130 that are associated with a subset of users (e.g., new employees, employees within a particular department or business unit, executive employees, etc.).

Subsequent to receiving plurality of deployment configurations 242, virtual machine provisioner 114 provisions virtual machines of virtual machines 116 in accordance with plurality of deployment configurations 242. As shown in FIG. 2, virtual machine provisioner 114 transmits a provisioning signal 244 to virtual machines 236A-236N to provision virtual machines 236A-236N in accordance with plurality of deployment configurations 242. Provisioning signal 244 includes instructions to provision a virtual machine in accordance with a deployment configuration of plurality of deployment configurations 242. For instance, provisioning signal 244 may include instructions for setting computing device settings, setting user preferences, installing applications, and/or the like. Virtual machine provisioner 114 determines link information for each of virtual machines 236A-236N. The link information is suitable for identifying and/or accessing one or more provisioned virtual machines, as described elsewhere herein. In accordance with an embodiment, the link information specifies each provisioned virtual machine of virtual machines 236A-236N. In accordance with an alternative embodiment, the link information specifies a pool of similarly provisioned virtual machines of virtual machines 236A-236N (e.g., virtual machines provisioned according to the same deployment configuration).

In accordance with an embodiment, provisioned virtual machines 236A-236N are updated automatically when an installed operating system or application is updated. Thus, provisioned virtual machines are maintained in a ready-to-use state that enables a user to interact with instances of an installed operating system and installed applications.

Referring back to FIG. 3, in step 308, link information is received from the virtual machine provisioner. For example, configuration manager 124 receives a link information signal 246 from virtual machine provisioner 114. Link information signal 246 includes link information corresponding to provisioned virtual machines 236A-236N. In accordance with an embodiment, link information signal 246 indicates user identities or deployment configurations associated with the link information.

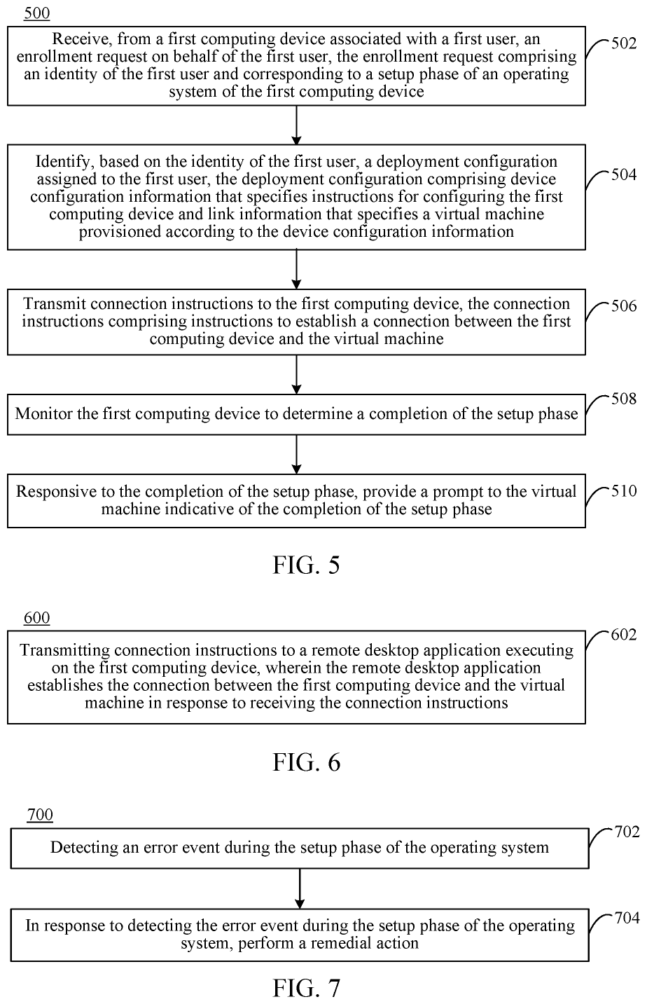

In step 310, the link information is stored in association with the device configuration information. For example, configuration manager 124 transmits storage signal 248 to data store 108 to store link information in association with device configuration information. Storage signal 248 comprises link information included in link information signal 246. As shown in FIG. 2, the link information is stored as link information 234 of deployment configurations 130. In accordance with an embodiment link information 234 is associated with (e.g., mapped to) corresponding device configuration information 232. As discussed below with respect to FIGS. 4 and 5, the storage of link information 234 in association with corresponding device configuration information 232 enables enrollment service 126 to access deployment configurations 130 and determine link information corresponding to a virtual machine that is provisioned according to a particular device configuration.

As discussed above, techniques described herein may enable virtual desktop during device setup in various ways, in embodiments. For example, FIG. 4 shows a block diagram of a system 400 for enabling virtual desktop during device setup in accordance with an example embodiment. As shown in FIG. 4, system 400 includes server 102A executing device management service 112 (that includes configuration manager 124, enrollment service 126, and installation manager 128), user computing device 106A executing operating system installation service 122A, data store 108 storing deployment configurations 130 (that includes device configuration information 232 and link information 234) and virtual machine 236A, as described above with reference to FIG. 1-3. As also shown in FIG. 4, enrollment service 126 includes a configuration identifier 448, an enrollment communication interface 450, and an event monitor 4552, and user computing device 106A includes a remote desktop application 454. Remote desktop application 454 is any application suitable for enabling a user to utilize a remote desktop. In accordance with an embodiment, remote desktop application 454 is pre-installed on user computing device 106A. Alternatively, remote desktop application 454 is installed as part of an operating system installation process (e.g., performed by executing operating system installation service 122A).

For illustrative purposes, system 400 is described below with respect to FIG. 5. FIG. 5 shows a flowchart 500 of a process for enabling virtual desktop during device setup in accordance with an example embodiment. System 400 of FIG. 4 may operate according to flowchart 500 in embodiments. Not all steps of flowchart 500 need be performed in all embodiments. Further structural and operational embodiments will be apparent to persons skilled in the relevant art(s) based on the following descriptions of FIGS. 4 and 5.

In accordance with one or more embodiments, prior to the steps of flowchart 500, a user associated with user computing device 106A turns on the device for the first time. This initiates the setup phase of operating system installation service 122A. As shown in FIG. 4, a communication link 456 is established between installation manager 128 and operating system installation service 122A. Communication link 456 enables installation manager 128 to manage and/or monitor operating system installation service 122A. In embodiments, operating system installation service 122A prompts the user for input during the initial steps of the setup phase. For example, operating system installation service 122A in accordance with an embodiment prompts the user to authenticate via authentication service 118 of FIG. 1. In this context, authentication service 118 authenticates credentials provided by the user and, if authentication service 118 determines the credentials are valid, provides an authentication token to operating system installation service 122A. Subsequent to receiving the authentication token, operating system installation service 122A generates an enrollment request 458 comprising the identity of the user and the authentication token, and the process continues to flowchart 500. Alternatively, operating system installation service 122A to enrollment steps of the setup phase. and the process continues to flowchart 500. Alternatively, operating system installation service 122A receives an authentication request to authenticate the user from enrollment service 126 (not shown in FIG. 4) in response to transmitting enrollment request 458 (e.g., without an authentication token) to enrollment service 126. In this alternative embodiment, operating system installation service 122A authenticates the user as described above and responds to the authentication request by providing the authentication token to enrollment service 126.

Flowchart 500 begins with step 502. In step 502, an enrollment request is received on behalf of a first user from a first computing device associated with the first user. The enrollment request comprises an identity of the first user and corresponds to a setup phase of an operating system of the first computing device. For example, enrollment communication interface 450 of enrollment service 126 receives enrollment request 458 from operating system installation service 122A. As discussed above, enrollment request 458 comprises an identity of the user associated with user computing device 106A (“User A” hereinafter) and corresponds to a setup phase of the operating system of user computing device 106A. Examples of the identity of User A include, but are not limited to, User A's e-mail address, User A's phone number, User A's username, and/or any other type of information that uniquely identifies User A. Alternatively, the identity of User A is a user group identity that corresponds to a plurality of users including User A (e.g., a department identity of users in a particular department, a company identity of employees of a company, a membership identity of members of a group or organization, a security identity of users of a security group, and/or the like). In accordance with an embodiment, enrollment request 458 comprises an authentication token that indicates User A's identity is valid. Alternatively, enrollment service 126 transmits a request to operating system installation service 122A to authenticate the identity.

In step 504, a deployment configuration assigned to the first user is identified based on the identity of the first user. The deployment configuration comprises device configuration information that specifies instructions for configuring the first computing device and link information that specifies a virtual machine provisioned according to the device configuration information. For example, enrollment communication interface 450 transmits an identification request 460 to configuration identifier 448. Identification request 460 comprises the identity of User A. Configuration identifier 448 accesses data store 108 to identify a deployment configuration 462 of deployment configurations 130 based on the identity of User A. For instance, configuration identifier 448 in accordance with an embodiment accesses a mapping of deployment configurations 130 to user identities to identify deployment configuration 462. Deployment configuration 462 comprises device configuration information that specifies instructions for configuring user computing device 106A and link information that specifies a virtual machine provisioned according to the device configuration information. For instance, the link information may specify a particular virtual machine or a pool of virtual machines, as described herein. Configuration identifier 448 provides deployment configuration 462 to enrollment configuration interface 450 and flowchart 500 continues to step 506.

As discussed above with respect to FIGS. 2 and 3, in some embodiments, deployment configurations are indirectly assigned to users. In this context, configuration identifier 448 determines attributes or user groups of the user based on the identity of the user included in identification request 460. For instance, configuration identifier 448 may access a map (e.g., stored locally by configuration identifier 448 or external to configuration identifier 448) that maps user identities to assigned attributes or user groups. Alternatively, identification request 460 (and/or enrollment request 458) includes attributes and/or user groups assigned to User A. In either case, configuration identifier 448 accesses data store 108 to identify one or more deployment configurations of deployment configurations 130 based on attributes and/or user groups User A is assigned to. In some embodiments, configuration identifier 448 may identify more than one deployment configuration. As a non-limiting example, suppose User A is a manager in a Department A. In this example, configuration identifier 448 may identify a first deployment configuration that is assigned to all employees in Department A and a second deployment configuration that is assigned to all manager users. Configuration identifier 448 may provide all deployment configurations to enrollment configuration interface 450, e.g., as a combined deployment configuration. Depending on the implementation, combined deployment configurations may specify modified information. For instance, link information of deployment configurations for non-manager users in Department A may specify a different provisioned virtual machine than link information of a combined deployment configuration for manager users in Department A.

In step 506, connection instructions are transmitted to the first computing device. The connection instructions comprise instructions to establish a connection between the first computing device and the virtual machine. For example, enrollment communication interface 450 transmits connection instructions 464 to remote desktop application 454 of user computing device 106A. Connection instructions 464 comprise instructions to establish a connection 466 between user computing device 106A and the virtual machine specified in the link information of deployment configuration 462. As shown in FIG. 4, connection instructions 464 are transmitted to remote desktop application 454, however, it is also contemplated herein that another application executing on user computing device 106A may receive connection instructions 464 and establish connection 466 (e.g., on behalf of or alternative to remote desktop application 454). Additional details regarding establishing connection 466 are discussed with respect to FIG. 6.

Connection 466 enables User A to interact with virtual machine 236A and applications installed thereon during the setup phase of user computing device 106A. In this context, virtual machine 236A includes the applications, settings, and/or policies that are in the process of being installed on user computing device 106A. Thus, User A is able to interact at user computing device 106A with instances of applications prior to the installation of the applications on user computing device 106A. In some embodiments, one or more applications installed on virtual machine 236A are virtual or “cloud” versions of the application being installed. In this context, the state of User A's work in the application is saved in remote storage (e.g., data store 108 or another storage not shown in FIG. 4) for access by user computing device 106A subsequent to the completion of the setup phase. In some embodiments, files created and/or saved on virtual machine 236A are stored in the remote storage for access by user computing device 106A subsequent to the completion of the setup phase.

In step 508, the first computing device is monitored to determine a completion of the setup phase. For example, event monitor 452 monitors user computing device 106A to determine a completion of the setup phase. As shown in FIG. 4, event monitor 452 receives a completion notification 468 from installation manager 128. Completion notification 468 indicates the setup phase is complete. In this context, installation manager 128 generates completion notification 468 by determining the setup phase of operating system installation service 122A is complete (via communication link 456). Event monitor 452 may actively monitor installation manager 128 for completion manager 128, periodically request installation progress from installation manager 128, or request installation progress in response to an external request (e.g., from User A or from an admin user). Additional details regarding event monitor 452 are discussed with respect to FIG. 7.

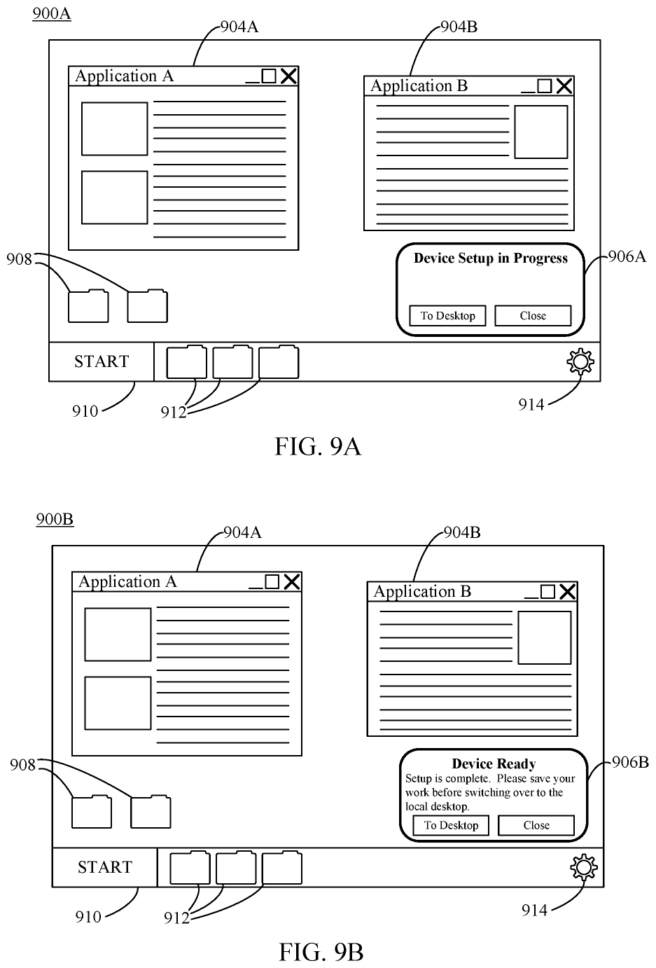

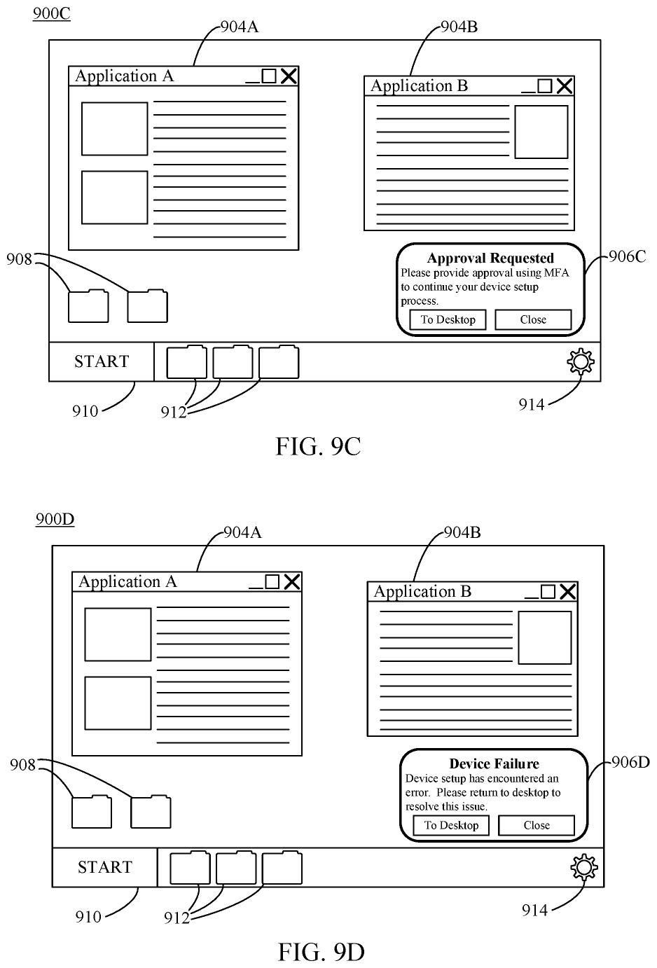

In step 510, responsive to the completion of the setup phase, a prompt is provided to the virtual machine indicative of the completion of the setup phase. For example, event monitor 452 provides a completion signal 470 to enrollment communication interface 450 in response to the completion of the setup phase. Enrollment communication interface 450 transmits completion instructions 472 to remote desktop application 454 in response to receiving completion signal 470. Completion instructions 472 comprise instructions to provide a prompt to virtual machine 236A indicative of the completion of the setup phase. For instance, remote desktop application 454 provides a prompt using connection 466 to indicate to virtual machine 236A that the setup phase is complete. In accordance with an embodiment, the prompt causes virtual machine 236A to display, alert, or otherwise notify User A that the setup phase of user computing device 106A is complete. Furthermore, completion signal 470 causes user computing device 106A to transition from usage of applications etc. provided by virtual machine 236A to usage of the corresponding newly setup applications etc. at user computing device 106A, including disconnecting from virtual machine 236A. Additional details regarding notifying users are discussed with respect to FIGS. 9A-9D. In accordance with an embodiment and subsequent to receiving the prompt, virtual machine 236A enables User A to return to operating system installation service 122A or otherwise exit the remote desktop of remote desktop application 454.

As discussed herein, embodiments transmit connection instructions to a computing device, the connection instructions comprising instructions to establish a connection between the computing device and a virtual machine. Systems, methods, and computer program products may transmit connection instructions in various ways, in embodiments. For example, FIG. 6 shows a flowchart 600 of a process for transmitting connection instructions in accordance with an example embodiment. Flowchart 600 is a further embodiment of step 506 of flowchart 500, as described with respect to FIG. 5. Enrollment communication interface 450 of FIG. 4 may operate according to flowchart 600, in embodiments. Flowchart 600 need not be performed in all embodiments. Further structural and operational embodiments will be apparent to persons skilled in the relevant art(s) based on the following description of FIG. 6.

Flowchart 600 includes step 602. In step 602, connection instructions are transmitted to a remote desktop application executing on a first computing device. The remote desktop application establishes the connection between the first computing device and the virtual machine in response to receiving the connection instructions. For example, enrollment communication interface 450 of FIG. 4 transmits connection instructions 464 to remote desktop application. In response to receiving connection instructions 464, remote desktop application 454 establishes a connection 466 between user computing device 106A and virtual machine 236A. In accordance with an embodiment, remote desktop application 454 establishes connection 466 directly with virtual machine 236A based on the link information included in connection instructions 464. Alternatively, remote desktop application 454 transmits a connection request to a virtual machine managing service (not shown in FIG. 4) to establish connection 466. In this context, virtual machine managing service manages a pool of virtual machines that includes virtual machines provisioned according to device configuration information associated with the link information included in connection instructions 464.

As discussed herein, event monitor 452 of FIG. 4 monitors computing device(s) (e.g., user computing device 106A) to determine a completion of a setup phase of the computing device. However, it is also contemplated herein that event monitors such as event monitor 452 may monitor computing devices for other events as well. Such events include, but are not limited to, an event requesting user input (i.e., an “input request event”), an event indicative of user input (i.e., a “user input event”), an event indicative of an error (i.e., an “error event”), and/or any other type of event regarding the setup phase, the user interacting with a provisioned virtual machine, and/or other processes associated with the operation of system 400.

As described above, event monitor 452 of FIG. 4 in accordance with an embodiment monitors the installation process of a computing device to determine if an error event has occurred. Event monitor 452 may operate in various ways to determine error events and/or perform remedial actions. For example, FIG. 7 shows a flowchart 700 of a process for performing a remedial action in accordance with an example embodiment. System 400 of FIG. 4 may operate according to flowchart 700, in embodiments. Not all steps of flowchart 700 need be performed in all embodiments. Further structural and operational embodiments will be apparent to persons skilled in the relevant art(s) based on the following description of FIG. 7.

Flowchart 700 begins with step 702. In step 702, an error event is detected during the setup phase of the operating system. For example, event monitor 452 of FIG. 4 detects an error event during the setup phase of the operating system of user computing device 106A. Example error events include, but are not limited to, an operating system installation failure (e.g., due to a corruption in the operating system file, an interruption in the installation process, etc.), an application installation failure (e.g., due to a corruption in an application file, a misconfiguration in the application, an incompatibility error, etc.), a network failure (e.g., a loss in a connection between user computing device 106A and a data store that stores files to be installed on user computing device 106A, a failure in connection 466 between user computing device 106A and virtual machine 236A), a device failure (e.g., due to a failure in a component of user computing device 106A, an outdated driver for a component of user computing device 106A, loss of power, etc.), a remote desktop failure (e.g., a failure in the operation of remote desktop application 454 and/or virtual machine 236A), and/or any other type of error that would be detected during the setup phase of the operating system of user computing device 106A.

Event monitor 452 may detect such error events in various ways. For example, as shown in FIG. 4, event monitor 452 receives an error alert 474 from operating system installation service 122A by enrollment communication interface 450. Error alert 474 may include information such as, but not limited to, the type of error that occurred, the time the error event occurred, whether or not user input is required, and/or any other information associated with the error event. In accordance with another embodiment, and as also shown in FIG. 4, event monitor 452 receives error alert 476 from remote desktop application 454 by enrollment communication interface 450. Error alert 476 may include information similar to error alert 474. In accordance with an embodiment, error alert 476 includes user input generated by the user interacting with remote desktop application 454. Such user input may include, for example, additional information regarding the user's experience regarding the error event. In accordance with another embodiment, and as also shown in FIG. 4, event monitor 452 receives error alert 478 from installation manager 128. In this context, installation manager 128 generates error alert 478 in response to determining an error event occurred during the installation of the operating system on user computing device 106A. Error alert 478 may include information similar to error alert 474.

In step 704, in response to detecting the error event during the setup phase of the operating system, a remedial action is performed. For example, in response to detecting the error event during the setup phase of the operating system of user computing device 106A (e.g., based on receiving error alerts 474, 476, and/or 478), event monitor 452 performs a remedial action. Example remedial actions include, but are not limited to, prompting a user of the computing device to provide user input, prompting the user to end the established connection with the virtual machine, ending the established connection with the virtual machine, performing a device repair operation, uninstalling and/or reinstalling an application, restarting the computing device, restarting the setup phase, rolling back the setup phase, and/or the like. In some embodiments, one or more remedial actions are performed, concurrently, partially concurrently, serially, etc. In some embodiments, different remedial actions are combined into a single remedial action.

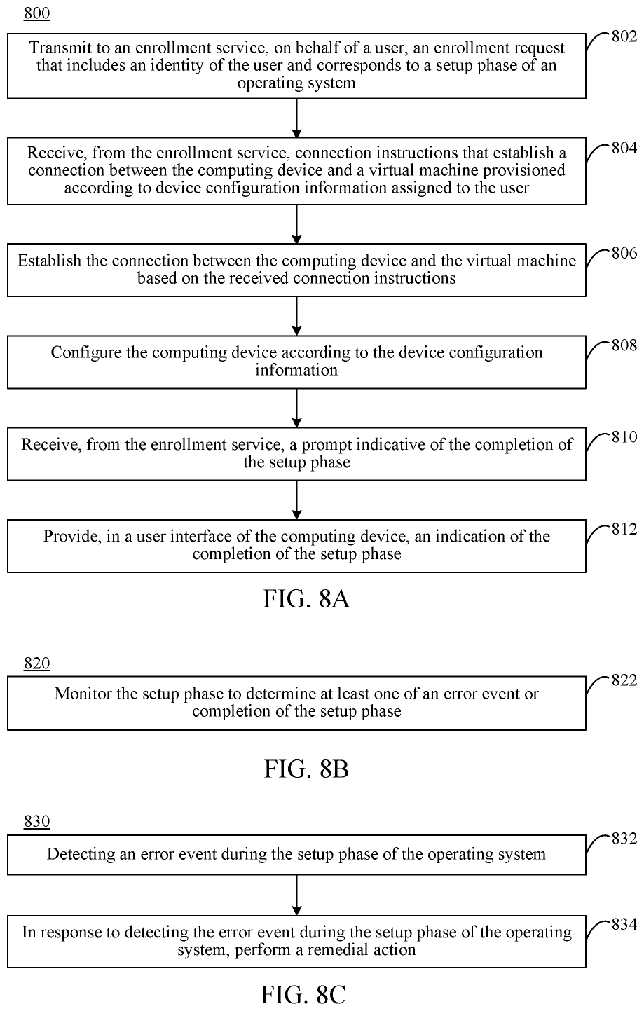

As described above, event monitor 452 in accordance with one or more embodiments performs the remedial action. Alternatively, another component of enrollment service 126 or system 400 performs the remedial action on behalf of event monitor 452. For instance, event monitor 452 in an embodiment transmits remedial action instructions 480 to enrollment communication interface 450 in response to detecting the error event during the setup phase of the operating system. Remedial action instructions 480 include instructions to perform one or more remedial actions. For example, suppose remedial action instructions 480 included instructions to prompt User A of user computing device 106A to provide user input. In this example, and as shown in FIG. 4, enrollment communication interface 450 transmits prompt instructions 482 to remote desktop application 454. Prompt instructions 482 include the instructions to prompt User A of user computing device 106A to provide user input. Responsive to receiving prompt instructions 482, remote desktop application 454 and/or virtual machine 236A prompt User A for input. In this example, responsive to receiving input (e.g., by User A interacting with a user interface of remote desktop application 454), remote desktop application 454 transmits a response (not shown in FIG. 4) to enrollment communication interface 450 that includes the user input. Additional details regarding prompting the user of a user computing device for user input are described with respect to FIG. 8C.

While FIG. 4 illustrates event monitor 452 transmitting remedial action instructions to enrollment communication interface 450 to transmit prompt instructions 482 to remote desktop application 454, remedial action instructions may be transmitted in other ways in addition to or alternative to the example depicted in FIG. 4. For instance, event monitor 452 in accordance with an embodiment transmits remedial action instructions to installation manager 128 to cause installation manager 128 to perform one or more remedial actions. Alternatively (or additionally), event monitor 452 transmits remedial action instructions to operating system installation service 122A (e.g., by enrollment communication interface 450 or installation manager 128) to cause operating system installation service 122A to perform one or more remedial actions. Moreover, event monitor 452 may transmit remedial action instructions to remote desktop application 454 other than (or in addition to) those described with respect to the example depicted in FIG. 4 (e.g., remedial action instructions to prompt User A to end connection 466, remedial action instructions to reestablish connection 466, and/or the like).

In accordance with an embodiment, the remedial action(s) is performed without interrupting the connection to the virtual machine. In this context, the user is able to continue interacting with the virtual machine using the remote desktop application concurrent to system 400 performing the remedial action(s).

As described herein, embodiments may be configured in various ways to enable a virtual desktop during device setup. Furthermore, a computing device may operate in various ways to initiate the setup process, communicate with an enrollment service, perform an installation process, and/or provide a user interface for a user to interact with a virtual machine during device setup. For instance, FIG. 8A shows a flowchart 800 of a process for enabling application access during computing device setup in accordance with an example embodiment. User computing device 106A of system 400 of FIG. 4 may operate according to flowchart 800 in embodiments. Not all steps of flowchart 800 need be performed in all embodiments. Further structural and operational embodiments will be apparent to persons skilled in the relevant art(s) based on the following description of FIG. 8A with respect to FIG. 4.

Flowchart 800 begins with step 802. In step 802, an enrollment request is transmitted to an enrollment service on behalf of a user. The enrollment request includes an identity of the user and corresponds to a setup phase of an operating system. For example, operating system installation service 122A of FIG. 4 transmits enrollment request 458 to enrollment service 126 on behalf of the user associated with user computing device 106A (“User A”, as described with respect to FIG. 5). As discussed elsewhere herein, enrollment request 458 includes an identity of the user and corresponds to a setup phase of the operating system of user computing device 106A. In accordance with an embodiment, operating system installation service 122A transmits enrollment request 458 after authenticating User A (e.g., with an authentication service such as authentication service 118). In this context, enrollment request 458 includes an indication that User A is authenticated (e.g., an authentication token received from authentication service 118).

In step 804, connection instructions are received from the enrollment service. The connection instructions establish a connection between the computing device and a virtual machine provisioned according to device configuration information assigned to the user. For example, remote desktop application 454 of FIG. 4 receives connection instructions 464 from enrollment service 126. Connection instructions 464 include instructions to establish a connection between user computing device 106A and virtual machine 236A, as described elsewhere herein (e.g., with respect to FIG. 5).

Alternatively, another application executing on user computing device 106A (e.g., operating system installation service 122A) receives connection instructions 464 and causes remote desktop application 454 to be launched on user computing device 106A. For instance, operating system installation service 122A, in response to receiving connection instructions 464, may request remote desktop application 454 to be installed on user computing device 106A. Once remote desktop application 454 is installed, operating system installation service 122A provides connection instructions 464 to remote desktop application 454 and flowchart 800 continues to step 806.

In step 806, the connection between the computing device and the virtual machine is established based on the received connection instructions. For example, remote desktop application 454 establishes connection 466 between user computing device 106A and virtual machine 236A. As described elsewhere herein, connection 466 enables User A to interact with virtual machine 236A and applications installed thereon during the setup phase of user computing device 106A.

In step 808, the computing device is configured according to the device configuration information. For example, operating system installation service 122A configures user computing device 106A according to the device configuration information. In accordance with one or more embodiments, step 808 is a subset of the “setup phase” of the operating system of (and the settings and applications of) user computing device 106A. In accordance with an embodiment, operating system installation service 122A communicates with installation manager 128 over communication link 456 as part of this process (e.g., to receive instructions, to receive files to install, to receive setting configurations, to provide status updates, to request files, to request instructions, etc.). In accordance with another embodiment, operating system installation service 122A accesses resources over a network (e.g., network 110) to configure the device according to device configuration information). For instance, operation system installation service 122A may retrieve application files, setting files, operating system files, and/or other files related to applications to be installed on, the operating system to be installed on, and/or the settings to be configured for user computing device 106A. The retrieved resources are installed on user computing device 106A in manners in accordance with an installation process for each resource.

In step 810, a prompt indicative of the completion of the setup phase is received from the enrollment service. For example, remote desktop application 454 of FIG. 4 receives completion instructions 472 from enrollment service 126 once the resources are installed at user computing device 106A. As described elsewhere herein, completion instructions 472 comprise instructions to provide a prompt to virtual machine 236A indicative of the completion of the setup phase.

In step 812, an indication of the completion of the setup phase is provided in a user interface of the computing device. For example, remote desktop application 454 provides an indication of the completion of the setup phase in a user interface of user computing device 106A. In accordance with an embodiment, the indication is provided by providing a prompt to virtual machine 236A indicative of the completion of the setup phase. In this context, virtual machine 236A displays, alerts, or otherwise notifies User A (via a user interface of user computing device 106A (e.g., a user interface of remote desktop application 454)) that the setup phase of user computing device 106A is complete. Additional details regarding notifying users are discussed with respect to FIGS. 9A-9D. In accordance with an alternative embodiment, remote desktop application 454 displays, alerts, or otherwise notifies User A that the setup phase of user computing device 106A is complete (e.g., without providing a prompt to virtual machine 236A).

As described elsewhere herein, enrollment services may include an event monitor that monitors the setup phase of a computing device. It is also contemplated that the computing device may monitor the setup phase. For instance, operating system installation service 122A of system 400 of FIG. 4 may monitor the setup phase of user computing device 106A. FIG. 8B shows a flowchart 820 of a process for monitoring the setup phase of a computing device, in accordance with an example embodiment. User computing device 106A of system 400 of FIG. 4 may operate according to flowchart 820 in embodiments. Further structural and operational embodiments will be apparent to persons skilled in the relevant art(s) based on the following description of FIG. 8B with respect to FIG. 4.

Flowchart 820 includes step 822. In step 822, the setup phase is monitored to determine at least one of an error event or completion of the setup phase. For example, operating system installation service 122 of FIG. 4 monitors the setup phase of user computing device 106A to determine if an error event occurs or if the setup phase is completed. In accordance with an embodiment, operating system installation service 122A provides alerts or status updates to enrollment service 126 (e.g., as error alert 474) or installation manager 128 of device management service 112 (e.g., over communication link 456). Operating system installation service 122A may automatically (e.g., periodically or continuously) provide such alerts or status updates. Alternatively, operating system installation service 122A provides an alert or status update in response to a request received from enrollment service 126 or installation manager 128.

As described above, operating system installation service 122A of FIG. 4 in accordance with an embodiment monitors the setup phase to determine if an error event has occurred. Operating system installation service 122A may operate in various ways to detect error events and/or perform remedial actions. For example, FIG. 8C shows a flowchart 830 of a process for performing a remedial action in accordance with an example embodiment. User computing device 106A of system 400 of FIG. 4 may operate according to flowchart 830 in embodiments. Not all steps of flowchart 830 need be performed in all embodiments. Further structural and operational embodiments will be apparent to persons skilled in the relevant art(s) based on the following description of FIG. 8C with respect to FIG. 4.

Flowchart 830 begins with step 832. In step 832, an error event is detected during the setup phase of the operating system. For example, operating system installation service 122A of FIG. 4 detects an error event during the setup phase of the operating system of user computing device 106A. Example error events include those described with respect to FIG. 4, other error events described herein, and/or other type of error detectable during the setup phase of the operating system of user computing device 106A. Operating system installation service 122A in accordance with one or more embodiments detects the error event and generates an error alert 474. Error alert 474 may include information such as, but not limited to, the type of error that occurred, the time the error event occurred, whether or not user input is required, and/or any other information associated with the error event. In accordance with an embodiment, operating system installation service 122A detects an error event based on a user's interaction with remote desktop application 454. In accordance with an alternative embodiment, operating system installation service 122A provides a generated error alert to installation manager 128 over communication link 456. In accordance with another alternative embodiment, operating system installation service 122A provides information associated with the setup phase (e.g., status updates, error codes, applications installed, unsuccessful installations, etc.) to enrollment service 126 and/or installation manager 128. In this context, enrollment service 126 (or a component thereof) and/or installation manager 128 detect the error on behalf of operating system installation service 122A based on the provided information.

In step 834, a remedial action is performed in response to detecting the error event during the setup phase of the operating system. For example, operating system installation service 122A performs a remedial action in response to detecting the error event during the setup phase of the operating system. Example remedial actions include, but are not limited to, those described with respect to FIG. 7, other remedial actions described herein, and/or any other remedial action intended to correct and/or resolve a detected error. For instance, operating system installation service 122A in accordance with an embodiment performs a remedial action by transmitting information associated with the detected error to enrollment service 126 and/or installation manager 128. In some embodiments, operating system installation service 122A performs multiple remedial actions. As a non-limiting example, operating system installation service 122A performs a first remedial action in an attempt to resolve an error. If the error is not resolved, operating system installation service 122A transmits error alert 474 to enrollment service 126 for further action.

In accordance with an embodiment, the remedial action(s) is/are performed without interrupting the connection to the virtual machine. In this context, the user is able to continue interacting with the virtual machine using the remote desktop application concurrent to system 400 performing the remedial action(s).

### III. Example Embodiments of Remote Desktop User Interfaces

As described herein, embodiments may be configured in various ways to enable a user to interact with a virtual machine using a remote desktop application. Such remote desktop applications include a remote desktop user interface (RDUI) that enables a user to interact with the virtual machine. The RDUI enables a user to utilize applications installed on the virtual machine, generate and/or organize files, and/or otherwise interact with the virtual machine in a manner similar to the desktop of the user's computing device after the completion of the setup phase.

Note that an RDUI may be implemented in various ways to perform its functions. For instance, FIG. 9A shows an example RDUI 900A for enabling a user to interact with applications at a virtual machine in accordance with an example embodiment. RDUI 900A as exemplarily illustrated and described is a component of a remote desktop application, such as remote desktop application 454 of FIG. 4 and is configured to interface with a virtual machine such as virtual machine 236A of FIGS. 2 and 4, in embodiments. RDUI 900A is described as follows.

As shown in FIG. 9A, RDUI 900A includes application windows 904A and 904B, a status window 906A, icons 908, and a taskbar 910. Application windows 904A and 904B each correspond to applications installed on the virtual machine to which the remote desktop application of RDUI 900A is connected to. Application windows 904A and 904B enable a user to interact with respective applications using RDUI 900A. Status window 906A is a window that displays the status of the setup phase of the user's computing device (e.g., user computing device 106A of FIGS. 1, 2, and 4). Icons 908 correspond to files, folders, applications, and/or other desktop icons of the virtual machine that enable a user to open and/or navigate to corresponding files, folders, applications, etc. Taskbar 910 includes a “START” button (e.g., for opening a start menu of the operating system), taskbar icons 912 (that provide functions similar to icons 908), and a settings button 914 (e.g., for opening a settings menu of the operating system).

As shown in FIG. 9A, status window 906A includes a “To Desktop” button and a “Close” button. The “To Desktop” button enables the user to navigate to the desktop of the computing device (e.g., by closing or suspending the remote desktop). The “Close” button closes status window 906A. In embodiments, prompts are displayed to a user via status window 906A. Additional details regarding status windows and such prompts are described below with respect to FIGS. 9B-9D.

As described herein, embodiments of enrollment services, such as enrollment service 126 of FIGS. 1 and 4, provide prompts to virtual machines. Such prompts may indicate, for example, status updates regarding the setup phase of the operating system installation process, a request for user input, the occurrence of an error event, and/or the like. For example, FIG. 9B shows an example RDUI 900B for presenting a prompt indicative of the completion of a setup phase in accordance with an example embodiment. As shown in FIG. 9B, RDUI 900B includes application windows 904A and 904B, icons 908, and taskbar 910, as described above with respect to FIG. 9A. As also shown in FIG. 9B, RDUI 900B includes a status window 906B. RDUI 900B operates in a similar manner as RDUI 900A as described above with respect to FIG. 9A, with the following differences.

Status window 906B is a window that displays the status of the setup phase of the user's computing device (e.g., user computing device 106A of FIGS. 1, 2, and 4). As shown in FIG. 9B, status window 906B includes a prompt that the setup phase is complete. For instance, RDUI 900B in accordance with an embodiment displays status window 906B subsequent to receiving the prompt provided by enrollment communication interface 450, as described with respect to step 510 of flowchart 500 of FIG. 5. Furthermore, the prompt indicates that the user should save work before switching over to the local desktop. Status window 906B also includes “To Desktop” and “Close” buttons, as described above with respect to status window 906A of FIG. 9A. In this context, the user can select the “To Desktop” button to navigate to the local desktop. In accordance with an embodiment, the connection to the virtual machine is disconnected when the user navigates to the local desktop.

As described herein, embodiments of enrollment services, such as enrollment service 126 of FIGS. 1 and 4, provide a prompt for user input to a virtual machine. A RDUI that interfaces with a virtual machine may display the prompt for user input in various ways, in embodiments. For example, FIG. 9C shows an example RDUI 900C for presenting a prompt for user input in accordance with an example embodiment. As shown in FIG. 9C, RDUI 900C includes application windows 904A and 904B, icons 908, and taskbar 910, as described above with respect to FIG. 9A. As also shown in FIG. 9C, RDUI 900C includes a status window 906C. RDUI 900C operates in a similar manner as RDUI 900A as described above with respect to FIG. 9A, with the following differences.

Status window 906C is a window that displays the status of the setup phase of the user's computing device (e.g., user computing device 106A of FIGS. 1, 2, and 4). As shown in FIG. 9C, status window 906C includes a prompt for user input. The prompt shown in FIG. 9C indicates the user is to provide a multi-factor authentication (MFA) approval to continue the setup phase of the user computing device. Examples of MFA include, but are not limited to, one-time code verification, hardware token verification, mobile application verification, biometric verification, and/or the like. A user may provide MFA approval using an application of a secondary user device (e.g., another computing device, a mobile phone, etc.) or by navigating to the local desktop (e.g., by selecting the “To Desktop” button. While the example prompt depicted in FIG. 9C requests user input external to RDUI 900C, it is also contemplated herein that the prompt displayed by status window 906C may include one or more interactive elements that enable a user to provide input by interacting with status window 906C. For instance, status window 906C may include a text input window that enables a user to provide a password, one-time code, hardware token code, and/or other credential. Alternatively, status window 906C may prompt the user to select from one or more choices (e.g., approving or denying access to a user account, approving or denying installation of an application, selecting from a list of user preferences or settings, and/or the like).

As described herein, embodiments of enrollment services, such as enrollment service 126 of FIGS. 1 and 4, provide a prompt that indicates an error event has occurred to a virtual machine. A RDUI that interfaces with a virtual machine may display the prompt in various ways, in embodiments. For example, FIG. 9D shows an example RDUI 900D for presenting a prompt to end an established connection with a virtual machine in accordance with an example embodiment. As shown in FIG. 9D, RDUI 900D includes application windows 904A and 904B, icons 908, and taskbar 910, as described above with respect to FIG. 9A. As also shown in FIG. 9D, RDUI 900D includes a status window 906D. RDUI 900D operates in a similar manner as RDUI 900A as described above with respect to FIG. 9A, with the following differences.

Status window 906D is a window that displays the status of the setup phase of the user's computing device (e.g., user computing device 106A of FIGS. 1, 2, and 4). As shown in FIG. 9D, status window 906D includes a prompt that the setup phase has failed. In this context, the prompt further indicates the user should navigate to the local desktop (e.g., to further perform one or more remedial actions). Status window 906D may also indicate the type of error that occurred, in embodiments. Alternative to requesting the user return to the local desktop, status window 906D in accordance with an embodiment presents a prompt for user input (e.g., to authorize a remedial action).

### IV. Example Computing Device Embodiments

As noted herein, the embodiments described, along with any circuits, components and/or subcomponents thereof, as well as the flowcharts/flow diagrams described herein, including portions thereof, and/or other embodiments, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

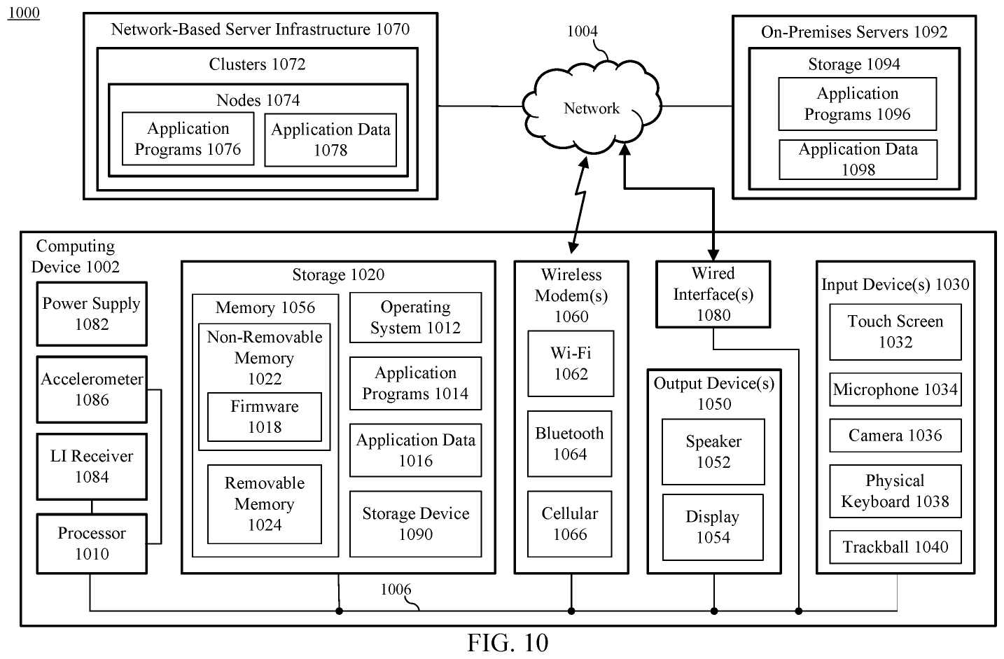

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 10. FIG. 10 shows a block diagram of an exemplary computing environment 1000 that includes a computing device 1002. Computing device 1002 is an example of server 102A, server 102B, server 102C, server 102N, admin computing device 104, user computing device 106A, and/or user computing device 106N, of FIG. 1, each of which may include one or more of the components of computing device 1002. In some embodiments, computing device 1002 is communicatively coupled with devices (not shown in FIG. 10) external to computing environment 1000 via network 1004. Network 1004 is an example of network 110 of FIG. 1. Network 1004 comprises one or more networks such as local area networks (LANs), wide area networks (WANs), enterprise networks, the Internet, etc., and may include one or more wired and/or wireless portions. Network 1004 may additionally or alternatively include a cellular network for cellular communications. Computing device 1002 is described in detail as follows.

Computing device 1002 can be any of a variety of types of computing devices. For example, computing device 1002 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Rift® of Facebook Technologies, LLC, etc.), or other type of mobile computing device. Computing device 1002 may alternatively be a stationary computing device such as a desktop computer, a personal computer (PC), a stationary server device, a minicomputer, a mainframe, a supercomputer, etc.

As shown in FIG. 10, computing device 1002 includes a variety of hardware and software components, including a processor 1010, a storage 1020, one or more input devices 1030, one or more output devices 1050, one or more wireless modems 1060, one or more wired interfaces 1080, a power supply 1082, a location information (LI) receiver 1084, and an accelerometer 1086. Storage 1020 includes memory 1056, which includes non-removable memory 1022 and removable memory 1024, and a storage device 1090. Storage 1020 also stores an operating system 1012, application programs 1014, and application data 1016. Wireless modem(s) 1060 include a Wi-Fi modem 1062, a Bluetooth modem 1064, and a cellular modem 1066. Output device(s) 1050 includes a speaker 1052 and a display 1054. Input device(s) 1030 includes a touch screen 1032, a microphone 1034, a camera 1036, a physical keyboard 1038, and a trackball 1040. Not all components of computing device 1002 shown in FIG. 10 are present in all embodiments, additional components not shown may be present, and any combination of the components may be present in a particular embodiment. These components of computing device 1002 are described as follows.

A single processor 1010 (e.g., central processing unit (CPU), microcontroller, a microprocessor, signal processor, ASIC (application specific integrated circuit), and/or other physical hardware processor circuit) or multiple processors 1010 may be present in computing device 1002 for performing such tasks as program execution, signal coding, data processing, input/output processing, power control, and/or other functions. Processor 1010 may be a single-core or multi-core processor, and each processor core may be single-threaded or multithreaded (to provide multiple threads of execution concurrently). Processor 1010 is configured to execute program code stored in a computer readable medium, such as program code of operating system 1012 and application programs 1014 stored in storage 1020. Operating system 1012 controls the allocation and usage of the components of computing device 1002 and provides support for one or more application programs 1014 (also referred to as “applications” or “apps”). Application programs 1014 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 1002 can communicate with any other component according to function, although not all connections are shown for ease of illustration. For instance, as shown in FIG. 10, bus 1006 is a multiple signal line communication medium (e.g., conductive traces in silicon, metal traces along a motherboard, wires, etc.) that may be present to communicatively couple processor 1010 to various other components of computing device 1002, although in other embodiments, an alternative bus, further buses, and/or one or more individual signal lines may be present to communicatively couple components. Bus 1006 represents one or more of any of several types of bus structures, including a memory bus or memory controller, a peripheral bus, an accelerated graphics port, and a processor or local bus using any of a variety of bus architectures.

Storage 1020 is physical storage that includes one or both of memory 1056 and storage device 1090, which store operating system 1012, application programs 1014, and application data 1016 according to any distribution. Non-removable memory 1022 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 1022 may include main memory and may be separate from or fabricated in a same integrated circuit as processor 1010. As shown in FIG. 10, non-removable memory 1022 stores firmware 1018, which may be present to provide low-level control of hardware. Examples of firmware 1018 include BIOS (Basic Input/Output System, such as on personal computers) and boot firmware (e.g., on smart phones). Removable memory 1024 may be inserted into a receptacle of or otherwise coupled to computing device 1002 and can be removed by a user from computing device 1002. Removable memory 1024 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 1090 may be present that are internal and/or external to a housing of computing device 1002 and may or may not be removable. Examples of storage device 1090 include a hard disk drive, a SSD, a thumb drive (e.g., a USB (Universal Serial Bus) flash drive), or other physical storage device.

One or more programs may be stored in storage 1020. Such programs include operating system 1012, one or more application programs 1014, and other program modules and program data. Examples of such application programs may include, for example, computer program logic (e.g., computer program code/instructions) for implementing one or more of device management service 112, virtual machine provisioner 114, virtual machine(s) 116, authentication service 118, admin application 120, operating system installation service 122A, operating system installation service 122N, configuration manager 124, enrollment service 126, installation manager 128, virtual machine 236A, virtual machine 236N, configuration identifier 448, enrollment communication interface 450, event monitor 452, remote desktop application 454, RDUI 900A, RDUI 900B, RDUI 900C, and/or RDUI 900D, along with any components and/or subcomponents thereof, as well as the flowcharts/flow diagrams (e.g., flowcharts 300, 500, 600, 700, 800, 820, and/or 830) described herein, including portions thereof, and/or further examples described herein.

Storage 1020 also stores data used and/or generated by operating system 1012 and application programs 1014 as application data 1016. Examples of application data 1016 include web pages, text, images, tables, sound files, video data, and other data, which may also be sent to and/or received from one or more network servers or other devices via one or more wired or wireless networks. Storage 1020 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 1002 through one or more input devices 1030 and may receive information from computing device 1002 through one or more output devices 1050. Input device(s) 1030 may include one or more of touch screen 1032, microphone 1034, camera 1036, physical keyboard 1038 and/or trackball 1040 and output device(s) 1050 may include one or more of speaker 1052 and display 1054. Each of input device(s) 1030 and output device(s) 1050 may be integral to computing device 1002 (e.g., built into a housing of computing device 1002) or external to computing device 1002 (e.g., communicatively coupled wired or wirelessly to computing device 1002 via wired interface(s) 1080 and/or wireless modem(s) 1060). Further input devices 1030 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 1054 may display information, as well as operating as touch screen 1032 by receiving user commands and/or other information (e.g., by touch, finger gestures, virtual keyboard, etc.) as a user interface. Any number of each type of input device(s) 1030 and output device(s) 1050 may be present, including multiple microphones 1034, multiple cameras 1036, multiple speakers 1052, and/or multiple displays 1054.

One or more wireless modems 1060 can be coupled to antenna(s) (not shown) of computing device 1002 and can support two-way communications between processor 1010 and devices external to computing device 1002 through network 1004, as would be understood to persons skilled in the relevant art(s). Wireless modem 1060 is shown generically and can include a cellular modem 1066 for communicating with one or more cellular networks, such as a GSM network for data and voice communications within a single cellular network, between cellular networks, or between the mobile device and a public switched telephone network (PSTN). Wireless modem 1060 may also or alternatively include other radio-based modem types, such as a Bluetooth modem 1064 (also referred to as a “Bluetooth device”) and/or Wi-Fi 1062 modem (also referred to as an “wireless adaptor”). Wi-Fi modem 1062 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 1064 is configured to communicate with another Bluetooth-capable device according to the Bluetooth short-range wireless technology standard(s) such as IEEE 802.15.1 and/or managed by the Bluetooth Special Interest Group (SIG).

Computing device 1002 can further include power supply 1082, LI receiver 1084, accelerometer 1086, and/or one or more wired interfaces 1080. Example wired interfaces 1080 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 1080 of computing device 1002 provide for wired connections between computing device 1002 and network 1004, or between computing device 1002 and one or more devices/peripherals when such devices/peripherals are external to computing device 1002 (e.g., a pointing device, display 1054, speaker 1052, camera 1036, physical keyboard 1038, etc.). Power supply 1082 is configured to supply power to each of the components of computing device 1002 and may receive power from a battery internal to computing device 1002, and/or from a power cord plugged into a power port of computing device 1002 (e.g., a USB port, an A/C power port). LI receiver 1084 may be used for location determination of computing device 1002 and may include a satellite navigation receiver such as a Global Positioning System (GPS) receiver or may include other type of location determiner configured to determine location of computing device 1002 based on received information (e.g., using cell tower triangulation, etc.). Accelerometer 1086 may be present to determine an orientation of computing device 1002.

Note that the illustrated components of computing device 1002 are not required or all-inclusive, and fewer or greater numbers of components may be present as would be recognized by one skilled in the art. For example, computing device 1002 may also include one or more of a gyroscope, barometer, proximity sensor, ambient light sensor, digital compass, etc. Processor 1010 and memory 1056 may be co-located in a same semiconductor device package, such as being included together in an integrated circuit chip, FPGA, or system-on-chip (SOC), optionally along with further components of computing device 1002.

In embodiments, computing device 1002 is configured to implement any of the above-described features of flowcharts herein. Computer program logic for performing any of the operations, steps, and/or functions described herein may be stored in storage 1020 and executed by processor 1010.

In some embodiments, server infrastructure 1070 may be present in computing environment 1000 and may be communicatively coupled with computing device 1002 via network 1004. Server infrastructure 1070, when present, may be a network-accessible server set (e.g., a cloud-based environment or platform). As shown in FIG. 10, server infrastructure 1070 includes clusters 1072. Each of clusters 1072 may comprise a group of one or more compute nodes and/or a group of one or more storage nodes. For example, as shown in FIG. 10, cluster 1072 includes nodes 1074. Each of nodes 1074 are accessible via network 1004 (e.g., in a “cloud-based” embodiment) to build, deploy, and manage applications and services. Any of nodes 1074 may be a storage node that comprises a plurality of physical storage disks, SSDs, and/or other physical storage devices that are accessible via network 1004 and are configured to store data associated with the applications and services managed by nodes 1074. For example, as shown in FIG. 10, nodes 1074 may store application data 1078.

Each of nodes 1074 may, as a compute node, comprise one or more server computers, server systems, and/or computing devices. For instance, a node 1074 may include one or more of the components of computing device 1002 disclosed herein. Each of nodes 1074 may be configured to execute one or more software applications (or “applications”) and/or services and/or manage hardware resources (e.g., processors, memory, etc.), which may be utilized by users (e.g., customers) of the network-accessible server set. For example, as shown in FIG. 10, nodes 1074 may operate application programs 1076. In an implementation, a node of nodes 1074 may operate or comprise one or more virtual machines, with each virtual machine emulating a system architecture (e.g., an operating system), in an isolated manner, upon which applications such as application programs 1076 may be executed.

In an embodiment, one or more of clusters 1072 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 1072 may be a datacenter in a distributed collection of datacenters. In embodiments, exemplary computing environment 1000 comprises part of a cloud-based platform such as Amazon Web Services® of Amazon Web Services, Inc., or Google Cloud Platform™ of Google LLC, although these are only examples and are not intended to be limiting.

In an embodiment, computing device 1002 may access application programs 1076 for execution in any manner, such as by a client application and/or a browser at computing device 1002. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 1002 may additionally and/or alternatively synchronize copies of application programs 1014 and/or application data 1016 to be stored at network-based server infrastructure 1070 as application programs 1076 and/or application data 1078. For instance, operating system 1012 and/or application programs 1014 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 1020 at network-based server infrastructure 1070.

In some embodiments, on-premises servers 1092 may be present in computing environment 1000 and may be communicatively coupled with computing device 1002 via network 1004. On-premises servers 1092, when present, are hosted within an organization's infrastructure and, in many cases, physically onsite of a facility of that organization. On-premises servers 1092 are controlled, administered, and maintained by IT (Information Technology) personnel of the organization or an IT partner to the organization. Application data 1098 may be shared by on-premises servers 1092 between computing devices of the organization, including computing device 1002 (when part of an organization) through a local network of the organization, and/or through further networks accessible to the organization (including the Internet). Furthermore, on-premises servers 1092 may serve applications such as application programs 1096 to the computing devices of the organization, including computing device 1002. Accordingly, on-premises servers 1092 may include storage 1094 (which includes one or more physical storage devices such as storage disks and/or SSDs) for storage of application programs 1096 and application data 1098 and may include one or more processors for execution of application programs 1096. Still further, computing device 1002 may be configured to synchronize copies of application programs 1014 and/or application data 1016 for backup storage at on-premises servers 1092 as application programs 1096 and/or application data 1098.

Embodiments described herein may be implemented in one or more of computing device 1002, network-based server infrastructure 1070, and on-premises servers 1092. For example, in some embodiments, computing device 1002 may be used to implement systems, clients, or devices, or components/subcomponents thereof, disclosed elsewhere herein. In other embodiments, a combination of computing device 1002, network-based server infrastructure 1070, and/or on-premises servers 1092 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 1020. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 1014) may be stored in storage 1020. Such computer programs may also be received via wired interface(s) 1080 and/or wireless modem(s) 1060 over network 1004. Such computer programs, when executed or loaded by an application, enable computing device 1002 to implement features of embodiments discussed herein. Accordingly, such computer programs represent controllers of the computing device 1002.

Embodiments are also directed to computer program products comprising computer code or instructions stored on any computer-readable medium or computer-readable storage medium. Such computer program products include the physical storage of storage 1020 as well as further physical storage types.

### V. Additional Example Embodiments

A system is described herein. The system comprises a processor circuit and a memory. The memory stores program code that is executable by the processor circuit. The program code comprises an enrollment service. The enrollment service receives, from a first computing device associated with a first user, an enrollment request on behalf of the first user. The enrollment request comprises the identity of the first user and corresponding to a setup phase of an operating system of the first computing device. The enrollment service identifies, based on the identity of the first user, a deployment configuration assigned to the first user. The deployment configuration comprises device configuration information that specifies instructions for configuring the first computing device and link information that specifies a virtual machine provisioned according to the device configuration information. The enrollment service transmits connection instructions to the first computing device. The connection instructions comprise instructions to establish a connection between the first computing device and the virtual machine. The enrollment service monitors the first computing device to determine a completion of the setup phase. Responsive to the completion of the setup phase, the enrollment provides a prompt to the virtual machine indicative of the completion of the setup phase.

In one implementation of the foregoing system, the instructions for configuring the first computing device comprise instructions to install an application on the first computing device and the established connection enables the user to interact at the first computing device with an instance of the application at the virtual machine prior to installation of the application on the first computing device.

In one implementation of the foregoing system, the enrollment service receives, from a second computing device associated with a second user, the deployment configuration assigned to the first user and stores the deployment configuration assigned to the first user in association with the identity of the first user.

In one implementation of the foregoing system, the enrollment service: provides a plurality of deployment configurations to a virtual machine provisioner, the plurality of deployment configurations including the deployment configuration assigned to the first user; receives, from the virtual machine provisioner, the link information; and stores the link information in association with the device configuration information.

In one implementation of the foregoing system, the enrollment service monitors the first computing device for an error event and, in response to detecting the error event during the setup phase of the operating system, performs a remedial action.

In one implementation of the foregoing system, the enrollment service performs the remedial action by performing the remedial action without interrupting the connection to the virtual machine.

In one implementation of the foregoing system, the enrollment service performs the remedial action by prompting the user to provide user input.

In one implementation of the foregoing system, the enrollment service performs the remedial action by prompting the user to end the established connection with the virtual machine.

In one implementation of the foregoing system, the enrollment service transmits the connection instructions to the first computing device by transmitting connection instructions to a remote desktop application executing on the first computing device. The remote desktop application establishes the connection between the first computing device and the virtual machine in response to receiving the connection instructions.

In one implementation of the foregoing system, the identity of the user comprises at least an individual user identity corresponding to the first user.

In one implementation of the foregoing system, the identity of the user comprises a user group identity corresponding to a plurality of users, the plurality of users comprising the first user.

In one implementation of the foregoing system, the link information specifies a pool of virtual machines provisioned according to the device configuration information, the pool of virtual machines comprising the virtual machine.

In one implementation of the foregoing system, the device configuration information specifies at least an application to be installed on the first computing device.

In one implementation of the foregoing system, the device configuration information specifies at least a device setting to be configured on the first computing device.

A method in an enrollment service is described herein. The method comprises: receiving, from a first computing device associated with a first user, an enrollment request on behalf of the first user, the enrollment request comprising the identity of the first user and corresponding to a setup phase of an operating system of the first computing device; identifying, based on the identity of the first user, a deployment configuration assigned to the first user, the deployment configuration comprising device configuration information that specifies instructions for configuring the first computing device and link information that specifies a virtual machine provisioned according to the device configuration information; transmitting connection instructions to the first computing device, the connection instructions comprising instructions to establish a connection between the first computing device and the virtual machine; monitoring the first computing device to determine a completion of the setup phase; and responsive to the completion of the setup phase, providing a prompt to the virtual machine indicative of the completion of the setup phase.

In one implementation of the foregoing method, the instructions for configuring the first computing device comprise instructions to install an application on the first computing device. The established connection enables the user to interact at the first computing device with an instance of the application at the virtual machine prior to installation of the application on the first computing device.

In one implementation of the foregoing method, the method further comprises: receiving, from a second computing device associated with a second user, the deployment configuration assigned to the first user; and storing the deployment configuration assigned to the first user in association with the identity of the first user.

In one implementation of the foregoing method, the method further comprises: providing a plurality of deployment configurations to a virtual machine provisioner, the plurality of deployment configurations including the deployment configuration assigned to the first user; receiving, from the virtual machine provisioner, the link information; and storing the link information in association with the device configuration information.

In one implementation of the foregoing method, said monitoring the first computing device comprises: in response to detecting an error event during the setup phase of the operating system, performing a remedial action.

In one implementation of the foregoing method, said performing a remedial action comprises at least one of: performing the remedial action without interrupting the connection to the virtual machine; prompting the user to provide user input; or prompting the user to end the established connection with the virtual machine.

In one implementation of the foregoing method, said transmitting connection instructions to the first computing device comprises transmitting connection instructions to a remote desktop application executing on the first computing device, wherein the remote desktop application establishes the connection between the first computing device and the virtual machine in response to receiving the connection instructions.

In one implementation of the foregoing method, the identity of the user comprises at least one of: an individual user identity corresponding to the first user or a user group identity corresponding to a plurality of users, the plurality of users comprising the first user.

In one implementation of the foregoing method, the link information specifies a pool of virtual machines provisioned according to the device configuration information, the pool of virtual machines comprising the virtual machine.

In one implementation of the foregoing method, the device configuration information specifies at least one of: an application to be installed on the first computing device or a device setting to be configured on the first computing device.

A computer-readable storage medium is described herein. The computer-readable storage medium has computer program logic recorded thereon that when executed by a processor circuit causes the processor circuit to perform a method. The method comprises: receiving, from a first computing device associated with a first user, an enrollment request on behalf of the first user, the enrollment request comprising the identity of the first user and corresponding to a setup phase of an operating system of the first computing device; identifying, based on the identity of the first user, a deployment configuration assigned to the first user, the deployment configuration comprising device configuration information that specifies instructions for configuring the first computing device and link information that specifies a virtual machine provisioned according to the device configuration information; transmitting connection instructions to the first computing device, the connection instructions comprising instructions to establish a connection between the first computing device and the virtual machine; monitoring the first computing device to determine a completion of the setup phase; and responsive to the completion of the setup phase, providing a prompt to the virtual machine indicative of the completion of the setup phase.

In one implementation of the foregoing computer-readable storage medium, the instructions for configuring the first computing device comprise instructions to install an application on the first computing device. The established connection enables the user to interact at the first computing device with an instance of the application at the virtual machine prior to installation of the application on the first computing device.

In one implementation of the foregoing computer-readable storage medium, the method further comprises: receiving, from a second computing device associated with a second user, the deployment configuration assigned to the first user; and storing the deployment configuration assigned to the first user in association with the identity of the first user.

In one implementation of the foregoing computer-readable storage medium, the method further comprises: providing a plurality of deployment configurations to a virtual machine provisioner, the plurality of deployment configurations including the deployment configuration assigned to the first user; receiving, from the virtual machine provisioner, the link information; and storing the link information in association with the device configuration information.

In one implementation of the foregoing computer-readable storage medium, said monitoring the first computing device comprises: in response to detecting an error event during the setup phase of the operating system, performing a remedial action.

In one implementation of the foregoing computer-readable storage medium, said performing a remedial action comprises at least one of: performing the remedial action without interrupting the connection to the virtual machine; prompting the user to provide user input; or prompting the user to end the established connection with the virtual machine.

In one implementation of the foregoing computer-readable storage medium, said transmitting connection instructions to the first computing device comprises transmitting connection instructions to a remote desktop application executing on the first computing device, wherein the remote desktop application establishes the connection between the first computing device and the virtual machine in response to receiving the connection instructions.

In one implementation of the foregoing computer-readable storage medium, the identity of the user comprises at least one of: an individual user identity corresponding to the first user or a user group identity corresponding to a plurality of users, the plurality of users comprising the first user.

In one implementation of the foregoing computer-readable storage medium, the link information specifies a pool of virtual machines provisioned according to the device configuration information, the pool of virtual machines comprising the virtual machine.

In one implementation of the foregoing computer-readable storage medium, the device configuration information specifies at least one of: an application to be installed on the first computing device or a device setting to be configured on the first computing device.

A method performed by a computing device that includes an operating system is described herein. The method includes: transmitting to an enrollment service, on behalf of a user, an enrollment request that includes an identity of the user and corresponds to a setup phase of the operating system; receiving, from the enrollment service, connection instructions that establish a connection between the computing device and a virtual machine provisioned according to device configuration information assigned to the user; establishing the connection between the computing device and the virtual machine based on the received connection instructions; configuring the computing device according to the device configuration information; receiving, from the enrollment service, a prompt indicative of the completion of the setup phase; and providing, in a user interface of the computing device, an indication of the completion of the setup phase.

In one implementation of the foregoing method, said configuring comprises: installing an application on the computing device; and said establishing comprises: enabling interactions by the user at the computing device with an instance of the application at the virtual machine prior to installation of the application on the computing device.

In one implementation of the foregoing method, the method further comprises monitoring the setup phase to determine at least one of: an error event, or completion of the setup phase.

### VI. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, computing devices, servers, device management services, virtual machine provisioners, applications, and/or data stores and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A system, comprising:
a processor circuit; and
a memory that stores program code that is executable by the processor circuit, the program code comprising:
an enrollment service that:
receives, from a first computing device associated with a first user, an enrollment request on behalf of the first user, the enrollment request comprising the identity of the first user and corresponding to a setup phase of an operating system of the first computing device;
identifies, based on the identity of the first user, a deployment configuration assigned to the first user, the deployment configuration comprising device configuration information that specifies instructions for configuring the first computing device and link information that specifies a virtual machine provisioned according to the device configuration information;
transmits connection instructions to the first computing device, the connection instructions comprising instructions to establish a connection between the first computing device and the virtual machine;
monitors the first computing device to determine a completion of the setup phase; and
responsive to the completion of the setup phase, provides a prompt to the virtual machine indicative of the completion of the setup phase.

2. The system of claim 1, wherein:
the instructions for configuring the first computing device comprise instructions to install an application on the first computing device; and
the established connection enables the user to interact at the first computing device with an instance of the application at the virtual machine prior to installation of the application on the first computing device.

3. The system of claim 1, wherein the enrollment service:
receives, from a second computing device associated with a second user, the deployment configuration assigned to the first user; and
stores the deployment configuration assigned to the first user in association with the identity of the first user.

4. The system of claim 1, wherein the enrollment service:
provides a plurality of deployment configurations to a virtual machine provisioner, the plurality of deployment configurations including the deployment configuration assigned to the first user;
receives, from the virtual machine provisioner, the link information; and
stores the link information in association with the device configuration information.

5. The system of claim 1, wherein the enrollment service:
monitors the first computing device for an error event; and
in response to detecting the error event during the setup phase of the operating system, performs a remedial action.

6. The system of claim 1, wherein the enrollment service transmits the connection instructions to the first computing device by:
transmitting connection instructions to a remote desktop application executing on the first computing device, wherein the remote desktop application establishes the connection between the first computing device and the virtual machine in response to receiving the connection instructions.

7. The system of claim 1, wherein the link information specifies a pool of virtual machines provisioned according to the device configuration information, the pool of virtual machines comprising the virtual machine.

8. A method in an enrollment service, comprising:
receiving, from a first computing device associated with a first user, an enrollment request on behalf of the first user, the enrollment request comprising the identity of the first user and corresponding to a setup phase of an operating system of the first computing device;
identifying, based on the identity of the first user, a deployment configuration assigned to the first user, the deployment configuration comprising device configuration information that specifies instructions for configuring the first computing device and link information that specifies a virtual machine provisioned according to the device configuration information;
transmitting connection instructions to the first computing device, the connection instructions comprising instructions to establish a connection between the first computing device and the virtual machine;
monitoring the first computing device to determine a completion of the setup phase; and
responsive to the completion of the setup phase, providing a prompt to the virtual machine indicative of the completion of the setup phase.

9. The method of claim 8, wherein:
the instructions for configuring the first computing device comprise instructions to install an application on the first computing device; and
the established connection enables the user to interact at the first computing device with an instance of the application at the virtual machine prior to installation of the application on the first computing device.

10. The method of claim 8, further comprising:
receiving, from a second computing device associated with a second user, the deployment configuration assigned to the first user; and
storing the deployment configuration assigned to the first user in association with the identity of the first user.

11. The method of claim 8, further comprising:
providing a plurality of deployment configurations to a virtual machine provisioner, the plurality of deployment configurations including the deployment configuration assigned to the first user;
receiving, from the virtual machine provisioner, the link information; and
storing the link information in association with the device configuration information.

12. The method of claim 8, wherein said monitoring the first computing device comprises:
in response to detecting an error event during the setup phase of the operating system, performing a remedial action.

13. The method of claim 12, wherein said performing a remedial action comprises at least one of:
performing the remedial action without interrupting the connection to the virtual machine;
prompting the user to provide user input; or
prompting the user to end the established connection with the virtual machine.

14. The method of claim 8, wherein said transmitting connection instructions to the first computing device comprises:
transmitting connection instructions to a remote desktop application executing on the first computing device, wherein the remote desktop application establishes the connection between the first computing device and the virtual machine in response to receiving the connection instructions.

15. The method of claim 8, wherein the identity of the user comprises at least one of:
an individual user identity corresponding to the first user; or
a user group identity corresponding to a plurality of users, the plurality of users comprising the first user.

16. The method of claim 8, wherein the link information specifies a pool of virtual machines provisioned according to the device configuration information, the pool of virtual machines comprising the virtual machine.

17. The method of claim 8, wherein the device configuration information specifies at least one of:
an application to be installed on the first computing device; or
a device setting to be configured on the first computing device.

18. A method performed by a computing device that includes an operating system, the method comprising:
transmitting to an enrollment service, on behalf of a user, an enrollment request that includes an identity of the user and corresponds to a setup phase of the operating system;
receiving, from the enrollment service, connection instructions that establish a connection between the computing device and a virtual machine provisioned according to device configuration information assigned to the user;
establishing the connection between the computing device and the virtual machine based on the received connection instructions;
configuring the computing device according to the device configuration information;
receiving, from the enrollment service, a prompt indicative of the completion of the setup phase; and
providing, in a user interface of the computing device, an indication of the completion of the setup phase.

19. The method of claim 18, wherein said configuring comprises:
installing an application on the computing device; and
wherein said establishing comprises:
enabling interactions by the user at the computing device with an instance of the application at the virtual machine prior to installation of the application on the computing device.

20. The method of claim 18, further comprising:
monitoring the setup phase to determine at least one of:
an error event, or
completion of the setup phase.
